(19) United States
(12) Patent Application Publication
(10) Pub. No.: US 2024/0065184 A1
(43) Pub. Date: Feb. 29, 2024

(54) LOG HANDLER

(71) Applicant: Liebherr-Werk Bischofshofen GmbH, Bischofshofen (AT)

(72) Inventors: Marco Eder, Zell am See (AT); Johannes Ortner, Saalfelden (AT)

(21) Appl. No.: 18/233,382

(22) Filed: Aug. 14, 2023

(30) Foreign Application Priority Data
Aug. 31, 2022 (DE) 20 2022 104 926.2

(51) Int. Cl. A01G 23/00; B25J 5/00; B25J 5/06; B25J 9/16; B60P 3/41

(52) U.S. Cl. CPC A01G 23/006; B25J 5/007; B25J 5/06; B25J 9/1638; B25J 9/1676; B60P 3/41

(57) ABSTRACT

The present invention relates to a log handler having a wheel loader base unit on which is located a working equipment which is movable relative to the base unit and which comprises a tool, in particular a wood grabbing device, wherein the log handler comprises first means which are configured to determine the payload, and the log handler comprises second means which are configured to determine, based on the payload determined by the first means and based on geometry data of the log handler, a parameter which is representative of the stability of the log handler.

### BACKGROUND OF THE INVENTION

The present invention relates to a log handler having a wheel loader base unit on which is located a working equipment movable relative to the base unit and comprising a tool, in particular a wood grabbing device.

Log handlers are required for handling wood materials, especially logs. They usually have a gripper device by means of which logs can be picked up. The working equipment movably arranged on the wheel loader base unit serves to lift or move the logs picked up by means of the gripper device.

At this point, it is noted that the working equipment may comprise or include a plurality of components movable relative to each other, preferably a boom and a swivel arm.

Log handlers are mostly operated in the wood processing industry, sometimes in rough terrain, which means special requirements in terms of tipping safety.

### SUMMARY OF THE INVENTION

The object underlying the present invention is that of further developing a log handler of the type mentioned above in such a way that safe and convenient operation is always ensured.

This object is achieved by a log handler having the features herein.

Accordingly, it is provided that the log handler comprises first means configured to determine the payload, and that the log handler comprises second means configured to determine a parameter representative of the stability of the log handler based on the payload determined by the first means and based on geometry data of the log handler.

The first means are thus used to determine the payload, i.e. the load located in the gripper device or other tool.

It is known from the prior art of wheel loaders to perform a payload determination. Wheel loaders are often equipped with a weighing device, which is also based on a payload determination.

The payload can be determined, for example, by measuring the pressure in one or more hydraulic cylinders of the working equipment. The determination of the payload is known to the skilled person.

The log handler according to the invention further comprises second means which serve to determine, based on the payload determined by the first means and based on geometry data of the log handler, a parameter representative of the stability of the log handler. Thus, the invention does not consist in the already known payload determination, but in the use of the determined payload for a further purpose, namely for determining or ensuring the stability of the log handler.

It is conceivable, for example, that the second means serve to determine the moment, for example, around the front axle or around a front tire of the log handler.

The current moment can be compared to a limit value, i.e. to a tilting moment, by means of comparison means.

Thus, the log handler may have a stability assistance system to ensure that the actual moment about a potential tip-over point remains below the tip-over moment.

Limiting means may be provided to prevent this limit from being exceeded in order to safely prevent the log handler from tipping over even in the event of an operator error.

The present invention further relates to a log handler having the features of the log handler comprising first means which are configured to determine the payload, and third means which are configured to carry out a range limitation of the working equipment, in particular the horizontal extension of the payload, based on the payload determined by the first means and based on geometry data of the log handler.

Also in this embodiment of the invention, the determined payload is used to determine another quantity, namely the maximum permissible horizontal reach at the determined payload, i.e. reach at which the log handler does not yet tip.

As with the above-mentioned stability assistance system, geometry data and the payload are used for the intelligent reach limitation. Prior art machines are known in which the reach, i.e. the maximum permissible horizontal outreach, is always determined on the assumption of maximum payload.

According to the invention, on the other hand, it is provided that the actually available and not the device-specific maximum possible payload is used for the maximum horizontal throat depth of the working equipment. Thus, with a correspondingly lower payload in the tool, a larger horizontal throat depth is possible.

A log handler having a combination of the features above is also part of the invention.

The above geometry data can be, for example, the relative position(s) of the working equipment components as well as the steering angle of the wheels. For example, the stability and the range of the horizontal projection are greater with the wheels in a straight position than with the wheels turned in.

In a further embodiment of the invention, the wheel loader base unit comprises a front carriage and a rear carriage and the geometry data includes the articulation angle between the front and rear carriages. If the articulation angle is zero, i.e., if the front and rear carriages are in line, the stability and range of horizontal outreach is greater than if the front carriage is angled.

It is also conceivable that the log handler has a display in which the stability or the value of the parameter representative thereof is shown. In this way, the operator of the log handler can always see how great the stability or the moment is and/or how great the distance is between the current torque and a tilting moment limit value.

It is also possible for the log handler to have a display that shows the current horizontal layout and/or its distance from a range limit.

It is conceivable that a characteristic diagram is stored that reflects the permissible working range of the working equipment as a function of the height of the payload, the distance of the payload from the front tire of the wheel loader base unit and from the payload.

As stated above, a preferred embodiment of the invention is that the log handler has a preferably payload-dependent reach limitation of the boom or working equipment in the horizontal direction.

In a further embodiment, it is provided that the log handler comprises a control device which is configured so that when a limit value of the maximum horizontal extension caused by a lifting movement of the boom of the working equipment is reached, the horizontal extension of the working equipment is prevented from increasing further by automatically counteracting the swivel arm.

Thus, in this embodiment of the invention, the movement of the boom or working equipment is no longer stopped when a height limit is reached, but instead, by means of control intervention, the swivel arm of the working equipment is moved toward the base unit to counteract an increase in horizontal extension, which is perceived as increased ease of operation since the movement does not have to be stopped.

The working equipment preferably comprises a swivel arm and a boom pivotably arranged thereon. The tool is located on the latter.

Preferably, a swing cylinder is provided for swinging the swivel arm forward and rearward relative to the wheel loader base unit and a lift cylinder is provided for swinging the boom up and down relative to the swivel arm.

At this point it is pointed out that the terms “a” and “one” do not necessarily refer to exactly one of the elements, although this is a possible version, but can also denote a plural of the elements. Likewise, the use of the plural also includes the presence of the element in question in the singular and, conversely, the singular also includes several of the elements in question.

Further, all of the features of the invention described herein may be claimed in any combination or in isolation from each other.

### BRIEF DESCRIPTION OF THE DRAWINGS

Further details and advantages of the invention are explained in more detail with reference to an exemplary embodiment shown in the drawing.

The figures show in:

FIG. 1: a schematic side view of a log handler according to the invention,

FIG. 2: a schematic side view of a log handler according to the invention with indicated torque about the front wheels,

FIG. 3: a schematic top view of a log handler according to the invention in the straight and in the bent state and

FIG. 4: a map for the purpose of range limitation.

### DESCRIPTION OF THE PREFERRED EMBODIMENTS

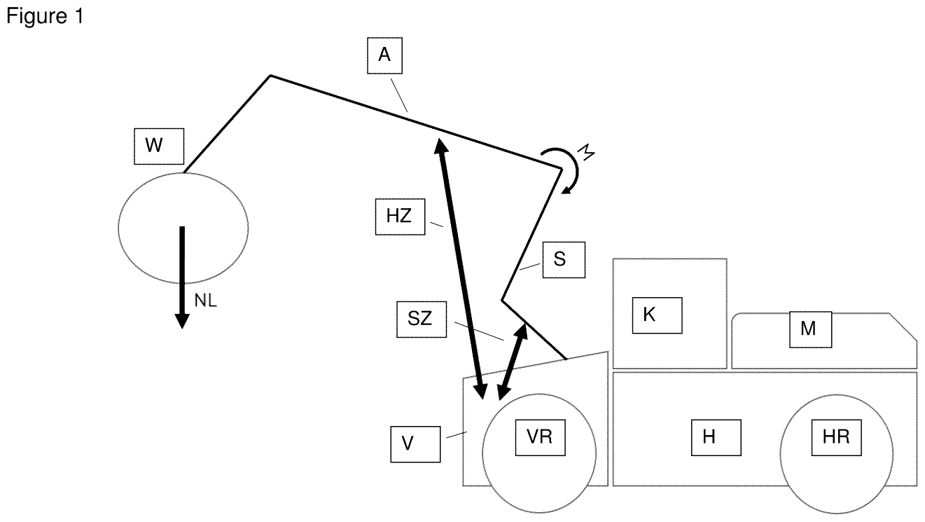

According to FIG. 1, the log handler comprises a wheel loader base unit with a front carriage V and a rear carriage H. The two are connected to each other by an articulated joint about a vertical axis. Both are connected to each other so that they can be pivoted about a vertical axis by means of an articulated joint.

On the front carriage there are two front wheels VR and on the rear carriage there are two rear wheels HR.

The rear carriage also includes the drivers cabin K and the engine room M.

The swivel arm S is arranged on the front carriage V so that it can swivel about a horizontal axis. It is actuated by means of the swivel cylinder SZ.

At the end of the swivel arm S there is arranged the boom A in a manner to be pivotable, the height position of which boom can be adjusted by means of the lifting cylinder HZ.

W denotes the tool, in particular a gripper tool, arranged at the end of the boom.

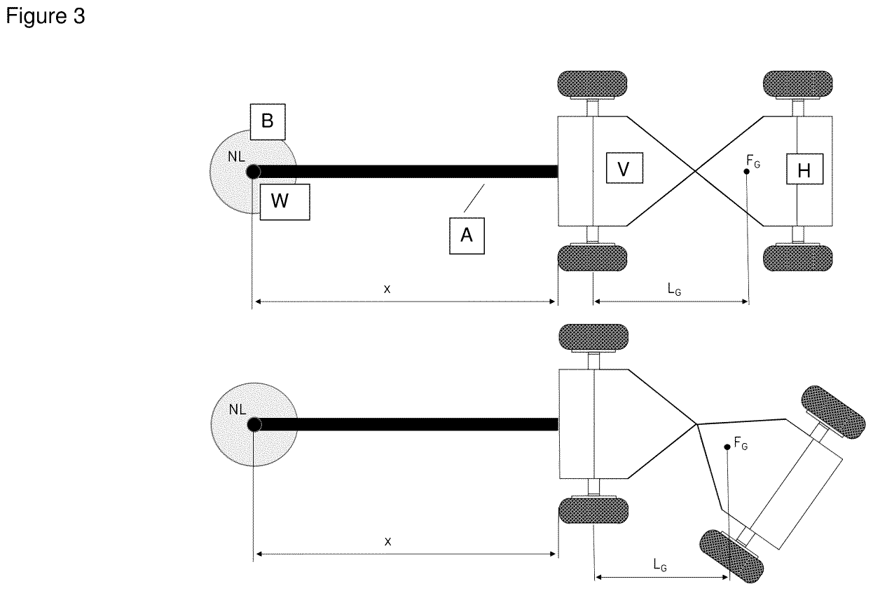

Inside the tool is the payload NL, indicated in FIG. 3 in the form of logs B, which exerts a downward force.

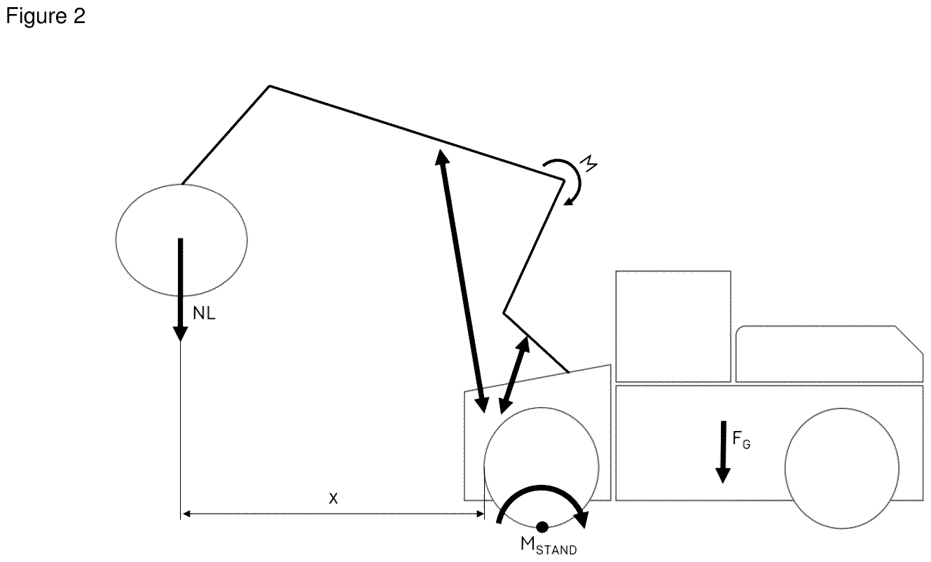

FIG. 2 shows the same log handler as FIG. 1. In FIG. 2, F G shows the weight force at the center of gravity of the wheel loader base carriage, which is the weight force of the log handler without payload.

Around the bearing surface of the front wheel, depending on the magnitude of the forces (payload and weight force), there is a moment M_{STAND}. If this exceeds a limit value, i.e. if it reaches the value for the tilting moment, the log handler tilts counterclockwise around the front wheel as shown in FIG. 2, which is of course undesirable.

To prevent this, the torque applied to the front tire is calculated from the payload and from one or more geometric variables, such as the height of the payload, the distance between the payload and the front tire, the steering angle, the articulation angle, etc. In this way, it is ensured that the resulting torque is not counterclockwise, i.e. that no tilting moment occurs. This ensures that there is no resulting torque that extends counterclockwise, i.e. that no tilting moment occurs.

The torque on the front tire is determined using the payload.

This can be determined, for example, from the pressure measured in the lifting cylinder by means of a sensor, the moment M applied between the swivel arm and the boom, and geometric variables.

One parameter that can be used to determine the torque and thus the stability is the articulation angle of the wheel loader base unit, as shown in FIG. 3.

If the base unit is straight (upper view), the distance L G between the center of gravity of the log handler and its front wheel center (_{LG, straight}) is greater than with a tucked base unit (_{LG, tucked}), as shown in the lower view. This means that a higher payload can be accommodated with a straight basic unit without the log handler tipping over than with a canted basic unit.

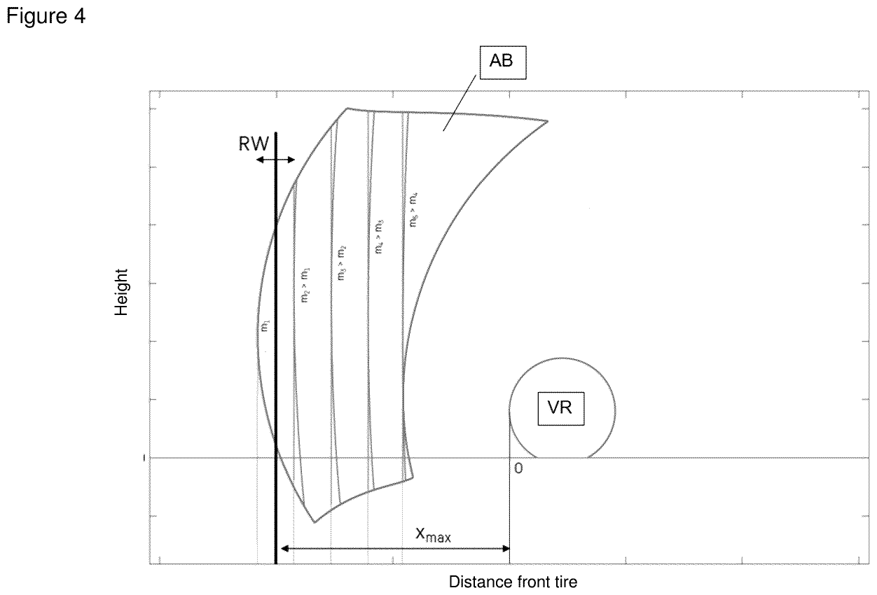

FIG. 4 shows a map of the operating range AB of the log handler. This can be stored in a memory of the device. The height of the payload above the ground is shown on the ordinate and the distance of the payload from the front tire of the log handler is shown on the abscissa.

The actual payload is marked with m. The permissible working range is limited on the right by the curved line, by the upper and lower left and by the respective left line marked with the index m₁, m₂, . . . m₅. The higher the index, the greater the payload.

Thus, with a comparatively high payload m₅ at the same height, the reach, i.e. the maximum possible horizontal projection is lower than with a lower payload m₁.

If the machine operator moves the load upwards at a given payload, e.g. m₄, by actuating the lifting cylinder HZ, the unit reaches its left-hand limit line of the working area, which cannot be crossed. The device recognizes this and, by actuating the swivel cylinder SZ, prevents the horizontal projection of the payload from being increased in order to prevent tipping.

The term “range limitation” RW is used to show a payload-dependent limitation of the range which cannot be exceeded in this embodiment. If the actual payload has exactly one of the values m₁, m₂ etc., the range marked accordingly with this load applies, which is limited on the left by a curved line, as shown in FIG. 4.

For example, if the actual payload is between m₁ and m₂, the working range is limited on the left by the vertical “Range Limit” line. Thus, in this case, the vertical line of the range limitation forms the left limit of the working range, which cannot be crossed. The same applies to payloads between m₂ and m₃, m₃ and m₄ etc., whereby the line shown applies to the exemplary case where the payload lies between m₁ and m₂. It shifts to smaller distances from the front tire as the payload increases, and to larger distances from the front tire as the payload decreases, as indicated by the double arrow on the “Range Limit” line.

With greater payload, this line thus moves towards smaller distances from the front tire, i.e. to the right as shown in FIG. 4.

1. Log handler with a wheel loader base unit, on which is located working equipment which is movable relative to the base unit and which comprises a tool, in particular a wood grabbing device, wherein the log handler comprises first means configured to determine the payload, and second means configured to determine, based on the payload determined by the first means and geometric data of the log handler, a parameter representative of the stability of the log handler.

2. Log handler with a wheel loader base unit, on which is located working equipment which is movable relative to the base unit and which comprises a tool, in particular a wood grabbing device, wherein the log handler comprises first means configured to determine the payload, and second means configured to carry out a range limitation of the working equipment in the horizontal direction on the basis of the payload determined by the first means and of geometric data of the log handler.

3. Log handler according to claim 1, wherein the log handler comprising third means configured to carry out a range limitation of the working equipment in the horizontal direction on the basis of the payload determined by the first means and geometric data of the log handler.

4. Log handler according to claim 1, wherein the log handler comprises at least two steerable wheels and the geometry data comprises the steering angle of the wheels.

5. Log handler according to claim 1, wherein the wheel loader base unit comprises a front carriage and a rear carriage, and the geometry data comprises the articulation angle between the front and rear carriages.

6. Log handler according to claim 1, wherein the log handler comprises a display in which the stability or the value of the parameter representative thereof is indicated.

7. Log handler according to claim 1, wherein means are provided which are configured such that an acoustic warning is emitted when a parameter representative of the stability is exceeded.

8. Log handler according to claim 1, wherein the parameter is the resultant torque about the front tires of the wheel loader base unit.

9. Log handler according to claim 1, wherein a characteristic diagram is stored in the log handler which reproduces the permissible working range of the working equipment as a function of the height of the payload, the distance of the payload from the front tire of the wheel loader base unit and from the payload itself.

10. Log handler according to claim 1, wherein the log handler has a preferably payload-dependent reach limitation of the working equipment in the horizontal direction.

11. Log handler according to claim 1, wherein the working equipment comprises a swivel arm and a control device is provided which is configured so that when a limit value of the maximum horizontal projection is reached, manual forward swiveling of the swivel arm is prevented.

12. Log handler according to claim 1, wherein the working equipment comprises a swivel arm and a boom pivotably arranged thereon, and a control device is provided which is configured such that, when a limit value of the maximum horizontal extension caused by a lifting movement of the boom is reached, the horizontal extension of the working equipment is prevented from increasing further by automatic counter-steering of the swivel arm.

13. Log handler according to claim 1, wherein the working equipment comprises a swivel arm and a boom pivotally mounted thereon and a wood grabbing device or other tool mounted on the boom.

14. Log handler according to claim 13, wherein there is a pivot cylinder for pivoting the swivel arm relative to the wheel loader base unit and a lift cylinder for pivoting the boom relative to the swivel arm.

15. Log handler according to claim 2, wherein the log handler comprises at least two steerable wheels and the geometry data comprises the steering angle of the wheels.

16. Log handler according to claim 2, wherein the wheel loader base unit comprises a front carriage and a rear carriage, and the geometry data comprises the articulation angle between the front and rear carriages.

17. Log handler according to claim 2, wherein the log handler comprises a display in which the stability or the value of the parameter representative thereof is indicated.

18. Log handler according to claim 2, wherein means are provided which are configured such that an acoustic warning is emitted when a parameter representative of the stability is exceeded.

19. Log handler according to claim 2, wherein the parameter is the resultant torque about the front tires of the wheel loader base unit.

20. Log handler according to claim 2, wherein a characteristic diagram is stored in the log handler which reproduces the permissible working range of the working equipment as a function of the height of the payload, the distance of the payload from the front tire of the wheel loader base unit and from the payload itself.
